(19) United States
(12) Patent Application Publication
(10) Pub. No.: US 2009/0107984 A1
(43) Pub. Date: Apr. 30, 2009

(54) Low Wattage Heating Pad

(76) Inventor: Gabriel S. Kohn, Boca Raton, FL (US)

Correspondence Address: Sunbeam Products, Inc., 2381 Executive Center Drive, Boca Raton, FL, 33431, US

(21) Appl. No.: 11/877,977

(22) Filed: Oct. 24, 2007

(51) Int. Cl. H05B 3/34; H05B 3/54

(52) U.S. Cl. 219/528; 219/549

(57) ABSTRACT

A therapeutic low wattage heating pad safe for use in a bed and to sleep with while in operation includes a pair of opposed multi-layer constructions housing a resistive heating wire. The heating pad is operable in a plurality of consistent heating modes at various temperature levels, as well as a cycling mode that offers a varying range of temperatures over a period of time.

### FIELD

The present disclosure is related generally to electrically heated pads. In particular, the present disclosure is directed to a low wattage electrically heated pad operable so as to allow for leaning against it, folding it, and sleeping with it. Further, the present disclosure is directed to an electrically heated pad operative to provide either a consistent or a cycled level of heat.

### BACKGROUND

The statements of this section merely provide background information related to the present disclosure and may not constitute prior art.

Medical research has shown that low level heat therapy over an extended period of time can provide significant benefits for patients experiencing muscle and soft tissue cramping, pulls or strains. It is understood that one of the primary driving factors behind such benefit is the forced vasodilation of the blood vessels in the treated area, in addition to the relaxation of local area muscles and a reduction in the firing of pain sensors.

Vasodilation is a physical response to a localized increase in temperature. The response has several distinct parts. The first three to five minutes of the reaction are generally attributed to a nervous reaction which is characterized by the relaxation of the muscle tissue immediately surrounding the local blood vessels thus allowing the vessels to expand and characterized by a significant increase in blood flow to the treated area. After this initial nervous system response, blood flow decreases moderately for a short period and then gradually begins to increase again until a sustained increase in blood flow to the area is reached after approximately 25-30 minutes of treatment. Clinical studies have determined that in order to achieve full vasodilation a heat treatment of at least 102° F. must be achieved in order to obtain the benefits from heat therapy.

There are, however, limitations to such thermal therapy treatments. In order to avoid unnecessary risk of burns to persons being treated, particularly those with neurological problems resulting in reduced sensitivities, the applied heat needs to be maintained within a limited safe range. Further, it has generally been shown that with lower temperature treatments, longer duration treatments are more effective. In fact, it has been shown that an eight hour treatment over two days can provide benefits for up to two days after completion of the treatment itself.

While the average person does not have four or more hours during their working day to remain essentially stationary to receive such a therapeutic heat treatment, there is one part of the day when significantly more that four hours are available for treatment—while the user is sleeping. As such, a low wattage electrically heated pad suitable for use in a bed and operable to sleep with while activated is provided.

### BRIEF SUMMARY

An electrically heated pad specifically designed for use in a bed and operable to be slept on, leaned against, or to be folded while in an activated state is provided. The heating pad may comprise a multi-layer construction of successive layers of water-resistant, electrically non-conductive materials separated by a non-woven batting. Two of such opposed multi-layer constructions may sandwich an electrically resistive heating wire. The opposed constructions may be joined at multiple locations across their surfaces to create retaining channels within which the heating wire is positioned in order to maintain a predetermined pattern.

In operation, the heating pad may operate in two primary modes—a level, uniform, or consistent heating mode and a cyclic heating mode. As designated by the user, the heating pad may be capable of providing a consistent level of heat as set by the user on a controller. Alternatively, the user may designate the heating pad to operate in a cyclic heating mode in which the heating pad may repeatedly cycle through a selected temperature range over predefined or user determined periods of time.

### BRIEF DESCRIPTION OF THE DRAWINGS

A more complete appreciation and many of the attendant advantages of the heating pad will be readily obtained as the same becomes better understood by reference to the following detailed description when considered in connection with the accompanying drawings, wherein similar reference numbers refer to similar elements.

FIG. 1 shows an exploded view of a heating pad construction;

FIG. 2 shows one exemplary heating wire pattern for use in a heating pad construction; and

FIG. 3 shows an electrical circuit diagram of the controller in block diagram format.

### DETAILED DESCRIPTION

While the heating pad may be susceptible to embodiment in different forms herein will be described in detail an exemplification of the principles of the heating pad which is not intended to limit the spirit and scope of the appended claims.

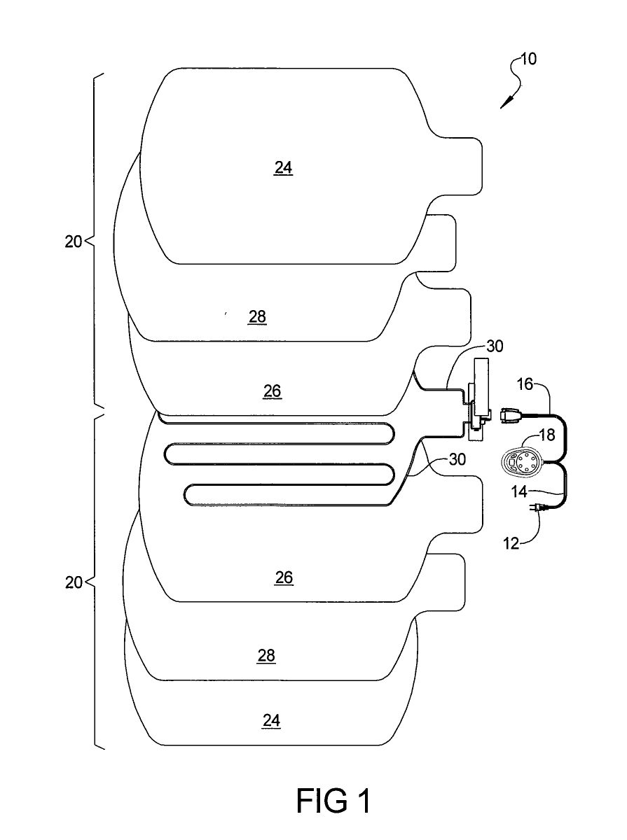

FIG. 1 shows an electrically heated pad generally designated 10, as well as a cord set 12, 14, and 16, and a controller 18. The overall dimensions of the heating pad 10 may be 24″ by 36″, a size sufficient to lend therapeutic heat treatment to an entire body region, but not so large as to thermally affect the entire body of a user.

The heating pad 10 comprises a pair of opposed multi-layer constructions 20 housed in an outer supplemental cover of shell 24. Each multi-layer construction 20 includes a water-resistant outer shell 24 and a scrim 26 separated by a layer of a non-woven batting material 28. The batting material 28 is included to both enhance the comfort of the pad 10 during its use, as well as to provide an air-insulation layer within the construction 20. The opposed constructions 20 are sandwiched around a resistive heating wire 30.

Without some mechanism for retaining the heating wire 30 in its designated pattern between the scrims 26, any physical manipulation of the heating pad 10 could result in its displacement. In order to secure the heating wire 30 in place, the two opposed scrims 26 are welded in such a manner as to produce retaining channels 32 between the looped heating wire 30. Additionally, the outer periphery of the pad 10 is welded together to secure together the two opposed constructions 20. Alternatively, the opposed scrims 26 of the heating pad 10 may be physically secured in any of the other well-known methods of securing component materials in a textile, including, but not limited to, sewing, gluing, or melting.

As mentioned above, the outer shells 24 are preferably a water-resistant material. Further, both the outer shells 24 and the scrims 26 comprise an electrically non-conductive heat-resistive material. The outer shells 24 and the scrims 26 may be comprised of a polymer. Such polymer may be one of a polyester, polyvinyl chloride, or polypropylene.

As the heating pad is a therapeutic heat source and it is contemplated for long duration use, the pad 10 can be thermally limited to reduce the potential for harm to a user. As such, the heating pad 10 operates at 45 watts or less than a standard electric blanket. Further, the resistive heating wire 30 may comprise a positive or negative temperature coefficient (PTC or NTC) wire. Such wires can operate along their length as discrete localized sensors suited for detecting localized hot spots and in the case of the PTC wire, increasing their resistance in response to an increase in the applied electrical current. Operation of such wires, as well as an exemplary safety circuit used in association therewith is discussed in greater detail in co-owned U.S. Pat. No. 6,355,912, issued to Allard on Mar. 12, 2002, and which is fully incorporated herein by reference.

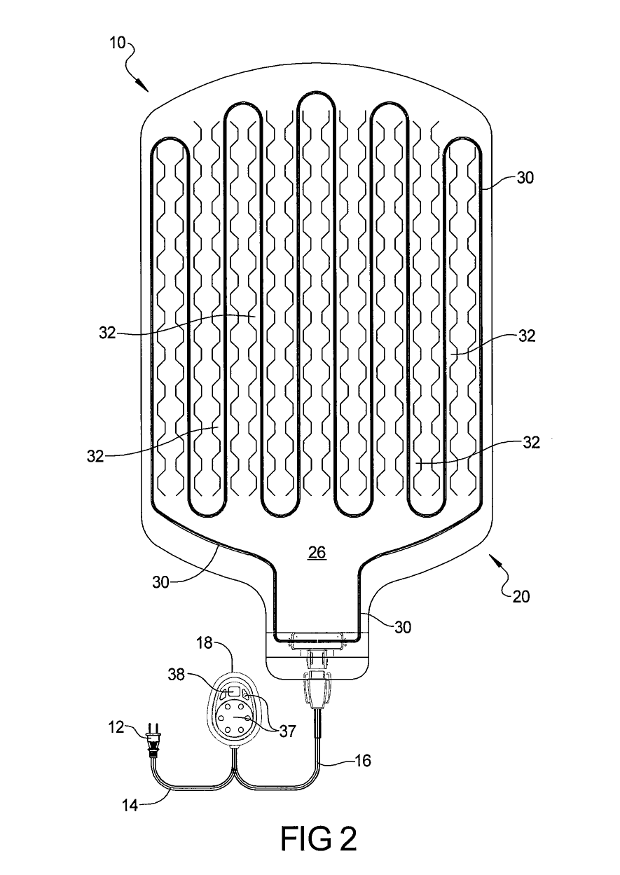

As best seen in FIG. 2, the heating wire 30 may be provided in an exemplary pattern sufficient to extend its generated heat to all parts of the heating pad 10. In an effort to avoid undesired localized hot spots and to prevent shorting out the wire 30 itself, care must be taken to maintain a minimum distance between loops of the heating wire 30 as it is wrapped throughout the heating pad 10.

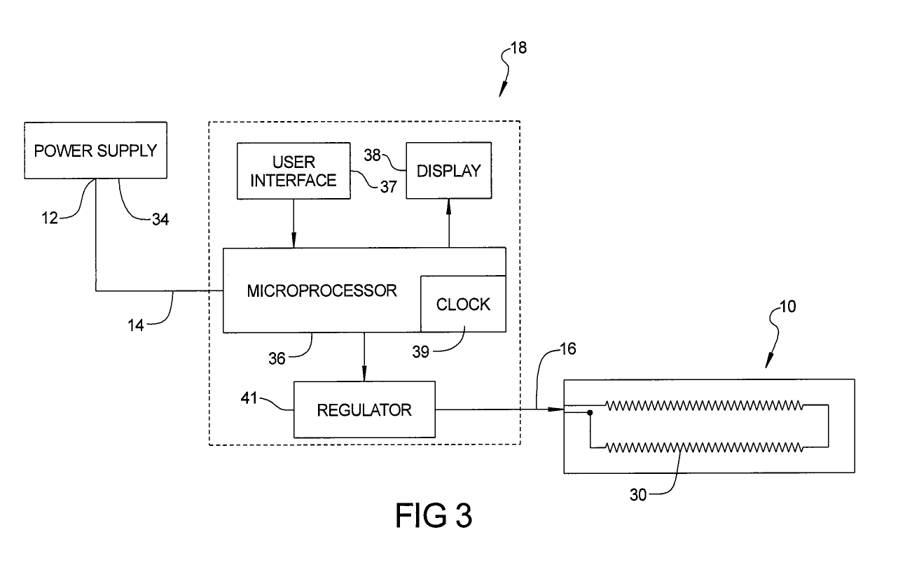

In operation and as best seen in FIG. 3, the heating pad 10 is a heat generator. Cord set 12, 14, and 16 draw power from a source 34, generally a common household outlet, through plug 12 and delivers it to controller 18 via cord 14. Controller 18 houses all of the electronics, including the microprocessor 36, required for varying the electrical draw needed for increasing or decreasing the thermal output of the resistive heating wire 30 in accordance with a selected user-demanded setting. The electricity is delivered to the resistive heating wire 30 via cord 16 which is connected to the heating wire 30 using detachable connectors (see FIGS. 1 and 2).

Controller 18 may comprise any of the many known rotary or switch type devices suitable for operating a multi-setting electrical appliance. The collection of switches, buttons, and other user-operable mechanisms designed to allow the user to select, set or otherwise operate the heating pad 10 in the various modes available, collectively form the user interface 37. The user interface 37 may include a plurality of individual heat settings, including a “HIGH”, a “LOW”, and multiple intermediate settings, as well as a setting specifically designated to initiate the cyclic heating operation of the pad 10. The user interface 37 may further include a joint or individual “ON” and “OFF” buttons or switches. Alternatively, the user interface 37 can include an individual “OFF” setting and the activation of the heating pad 10 may be achieved by default when the heating pad 10 is set to “LOW.” Finally, the controller 18 may include an at least two digit display 38 associated with the microprocessor 36 for indicating the currently selected setting of the heating pad 10.

During the cyclic heating mode, the microprocessor 36 in cooperation with an internal clock 39 operates to control both the time and temperature settings of the heating pad 10 based on a pre-programmed pattern. Similarly, driven by signals from the microprocessor 36, regulator 41 may serve to alter the current flow into resistive heating wire 30 to appropriately adjust the temperature as set by the user through user interface 37 whether the heating pad 10 is operating in the constant temperature mode, the timed mode, or as pre-programmed in the cyclic heating mode. While any cyclic heating pattern can be used, an exemplary cycle pattern may raise the heating pad's temperature to between 120° and 125° F. over the first thirty minutes of the cycle. After maintaining such temperature for a predetermined period of time, the pad 10 may cycle its temperature back down to between 105° and 110° F. and remain at that level for a period of approximately thirty minutes. The pad 10 can continue to cycle between the higher and lower temperature ranges for any period of time. The heating pad 10 may include an auto-off feature that terminates the operation of the pad 10 regardless of the mode in which it is operating after a maximum of ten hours.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the disclosure.

What is claimed is:

1) A low wattage heating pad, comprising:
a pair of opposed multi-layer constructions housing a resistive heating wire therebetween;
wherein at least two of said multi-layers of said opposed constructions are joined in such a manner as to generate retaining channels through which the heating wire extends; and
wherein said pad is operable in a consistent heating mode and a cyclical heating mode.

2) The heating pad of claim 1, wherein each of the pair of multi-layer constructions further comprises:
an outer shell layer;
a scrim; and
a non-woven batting layer between the outer shell layer and the scrim.

3) The heating pad of claim 2, wherein the outer shell layer and the scrim comprise a water-resistant and electrically non-conductive material.

4) The heating pad of claim 3, wherein said water-resistant and electrically non-conductive material is comprised of one of a material from the group consisting of polyester, polyvinyl chloride, and polypropylene.

5) The heating pad of claim 1, wherein the resistive heating wire comprises a positive or negative temperature coefficient wire.

6) The heating pad of claim 1, wherein said level heating mode includes a plurality of individual heating levels selectable by a user.

7) A low wattage therapeutic heating pad, comprising:
a heating wire housed within a multi-layer construction;
wherein said heating pad operates at or less than 45 watts during use; and
wherein the heating pad is operable in a plurality of modes including a consistent heating mode and a heat cycling mode.

8) The low wattage heating pad of claim 7, wherein the heating wire comprises a positive or negative temperature coefficient wire.

9) The low wattage heating pad of claim 7, wherein said multi-layer construction further comprises a pair of opposed multi-layer shells comprising:
an outer shell layer;
a scrim; and
a non-woven batting layer between the outer shell layer and the scrim.

10) The low wattage heating pad of claim 7, wherein the heat cycling mode includes:
repeatedly cycling the temperature of the heating pad to a first higher temperature range and maintaining that first higher temperature range for a first period of time; and
cycling the temperature from said first higher temperature range to a second lower temperature range and maintaining the second lower temperature range for a second period of time.

11) The low wattage heating pad of claim 10, wherein the first higher temperature range is between 120° and 125° F.

12) The low wattage heating pad of claim 10, wherein the second lower temperature range is between 105° F. and 10° F.

13) The low wattage heating pad of claim 10, wherein the first and second periods of time are the same.

14) The low wattage heating pad of claim 11, wherein the first and second periods of time are thirty minutes.

15) The low wattage heating pad of claim 10, wherein the first and second periods of time are each unique.

16) The low wattage heating pad of claim 15, wherein the first and second periods of time and the first higher and second lower temperature ranges are user-definable.

17) A heating pad operable in a plurality of user-selectable modes including a consistent heating mode and a heat cycling mode.

18) The heating pad of claim 17, comprising:
a heating wire housed within a multi-layer construction;
wherein said heating wire is a positive or negative temperature coefficient wire.

19) The heating pad of claim 18, wherein said heating pad operates at or less than 45 watts during use.

20) The heating pad of claim 17, wherein the inner and outer layers of said heating pad comprise a water-resistant and electrically non-conductive material, wherein said material is comprised of one of a material from the group consisting of polyester, polyvinyl chloride, and polypropylene.
